(19) United States
(12) Patent Application Publication
(10) Pub. No.: US 2011/0294040 A1
(43) Pub. Date: Dec. 1, 2011

(54) PROTON-CONDUCTING HYBRID GLASS AND METHOD FOR MANUFACTURING THE SAME

(75) Inventors: Yong-il Park, Gumi-si (KR); Myung Hoon Oh, Suseong-gu (KR); Sung Bum Park, Gyeongju-si (KR); Sang Hyun Lee, Dong-gu (KR); In Jung Kim, Anseong-si (KR); Jin Hun Jo, Gyeongju-si (KR); Man Seok Park, Gumi-si (KR)

(73) Assignee: KUMOH NATIONAL INSTITUTE OF TECHNOLOGY INDUSTRY-ACADEMIC COOPERATION FOUNDATION, Gyeongbuk (KR)

(21) Appl. No.: 13/149,020

(22) Filed: May 31, 2011

(30) Foreign Application Priority Data
May 31, 2010 (KR) 10-2010-0050946

(51) Int. Cl. H01M 8/12; H01B 1/06; B05D 5/12

(52) U.S. Cl. 429/495; 427/126.2; 252/520.5; 252/519.14

(57) ABSTRACT

Proton-conducting hybrid glass and a method for manufacturing the same. The proton-conducting hybrid glass has CsPWA created inside the pores of borosilicate glass. The proton-conducting hybrid glass can be used as an electrolyte for electrochemical devices, such as fuel cells and sensors. When the proton-conducting hybrid glass is used as an electrolyte membrane for a fuel cell, excellent thermal and chemical stability is realized in the range from a high temperature to an intermediate temperature of 120° C. A high proton conductivity of 10⁻³S/cm or higher and good catalytic activity are realized. In addition, high volumetric stability and excellent moisture retention characteristics in high and intermediate temperature ranges are achieved.

### CROSS REFERENCE TO RELATED APPLICATION

The present application claims priority from Korean Patent Application Number 10-2010-0050946 filed on May 31, 2010, the entire contents of which application are incorporated herein for all purposes by this reference.

### BACKGROUND OF THE INVENTION

1. Field of the Invention

The present invention relates to proton-conducting hybrid glass and a method for manufacturing the same. More particularly, the present invention relates to proton-conducting hybrid glass, which can be used as an electrolyte for electrochemical devices, such as fuel cells and sensors, and a method for manufacturing the same.

2. Description of Related Art

Proton Exchange Membrane Fuel Cells (PEMFCs) of the related art are not economical competitive due to their high manufacturing cost, which is attributable to the use of an expensive catalyst. In order to improve on this, a variety of studies are being conducted with the intention of decreasing the use of catalysts. However, it is still difficult to decrease the use of catalysts, since PEMFCs have low catalytic efficiency due to their low operation temperature of 100° C. or less.

Recently, studies are being conducted with the aim of decreasing the use of catalysts by increasing the operation temperature. However, if a high-molecular membrane is used as an electrolyte membrane, proton-conducting characteristics decrease with increase in the temperature, since the electrolyte deteriorates at high temperatures. Consequently, there are drawbacks, such as a lack of durability and a decrease in efficiency. As a specific example, a Nafion™ membrane, available from DuPont, can be considered. Referring to the structure of the Nafion™ membrane, a chain having a sulfuric acid functional group is bonded to a Polytetrafluoroethylene (PTFE)-based polymer. Although this membrane has high proton conductivity and chemical stability, it has a problem in that it deteriorates at temperatures of 120° C. or higher.

In order to develop an electrolyte membrane that can realize stable conductivity characteristics over an intermediate temperature range, oxide-based proton conductors have been introduced as an alternative to high-molecule groups. Specifically, proton-conducting glass has been developed.

The role of a proton as a charge carrier inside glass has been overlooked because the bonding strength of O—H is very high. Therefore, most studies on the electrical conductivity of glass have been limited to alkaline ion conduction and electron conduction. However, H. Namikawa et al. first reported that BaO—P₂O₅ based glass, which does not contain alkali, exhibits high proton conductivity. After that, Y. Abe et al. reported a conduction mechanism of “super proton-conducting glass” by synthesizing super proton-conducting glass, which has a high conductivity of 10⁻⁴S/cm or more at room temperature, based on phosphate glass. This suggests the candidacy of the proton-conducting glass as an oxide-based room-temperature proton conductor.

It is reported that the proton conductivity of oxide glass is proportional to the square of the concentration of mobile protons, and that the activation energy of conduction is determined by the position and concentration of an O—H Infrared (IR) absorption band. In particular, the mobility of mobile protons depends greatly on the composition and structure of glass.

After having studied the structure and bonding status of H₂O, Scholze et al. found that no molecular moisture exists in glass made by typical high temperature melting, but that molecular moisture resides in the form of —OH (hydroxyl group) together with impurities inside the glass structure. Due to the hydroxyl group, there are three IR absorption bands (band 1: 3,600 cm⁻¹, band 2: 2,900 cm⁻¹, and band 3: 2,350 cm⁻¹). Here, band 1 indicates hydrogen bond-free protons and bands 2 and 3 indicate hydrogen-bonded protons.

Y. Abe et al. reported that most of the —OH group protons corresponding to band 1 are immobile and that band 2 protons are mobile protons, thus contributing to conduction. Oxygen ions inside glass generate bridging oxygen and non-bridging oxygen, thereby forming band 2, which indicates hydrogen bonding. Consequently, as the strength of the hydrogen bonding of the hydroxyl group (X—OH, X=glass forming ion) to non-bridging oxygen adjacent to terminal protons increases, the O—H bonding force decreases further, thereby greatly increasing the mobility of proton. Activation energy also decreases, and conductivity increases. Y. Abe et al. reported that the concentration of mobile protons is the most important factor in determining the conductivity of proton-conducting glass, and the phenomenon in which the concentration of protons greatly increases when glass contains moisture.

T. Uma and M. Nogami reportedly operated a H₂/O₂ fuel cell that exhibited very high conductivity (10⁻² S/cm or more) at 50° C. and 90% Relative Humidity (RH) using P₂O₅-SiO₂-Phospho Molybdic Acid (PMA) glass. However, solid acid, which tends to be easily eluted, is mixed in order to increase conductivity, since the problem of poor stability, which is caused by the large amount of P₂O₅, has not been overcome. This, consequently, causes the glass structure to be chemically fragile, e.g., causes the glass to fracture. Furthermore, porous glass has a problem of residual open poles. If the closing of pores is not induced to the maximum, there is a great possibility that the porous glass may cause potential drop due to the penetration of fuel gas. Accordingly, the proton-conducting glass is plagued by the problem of low chemical stability.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide novel proton-conducting hybrid glass, which is distinguished from the high-molecular electrolytes used in existing Proton Exchange Membrane Fuel Cells (PEMFCs), and which has high thermal and volumetric stability and excellent moisture maintenance characteristics in high and intermediate temperature ranges, and a method for manufacturing the same.

An aspect of the present invention provides a proton-conducting hybrid glass that includes cesium (Cs) salt of phosphotungstic acid (CsPWA) created inside pores of borosilicate glass.

Another aspect of the present invention provides a method for manufacturing a proton-conducting hybrid glass. The method has a cycle that includes the steps of: impregnating porous borosilicate glass, which contains pores therein, in a Cs carbonate solution; and re-impregnating the porous borosilicate glass, which is impregnated in the Cs carbonate solution, in a Phosphotungstic Acid (PWA) solution, thereby creating CsPWA inside the pores of the borosilicate glass.

A further aspect of the present invention provides a fuel cell, which uses the above-described proton-conducting hybrid glass an electrolyte.

According to exemplary embodiments of the invention, the fuel cell using the proton-conducting hybrid glass of the invention as an electrolyte exhibits excellent thermal and chemical stability in the range from a high temperature to an intermediate temperature, which is no lower than 100° C. In addition, since the proton-conducting hybrid glass of the invention exhibits a high proton conductivity of 10⁻³S/cm or more and good catalytic activity, the fuel cell using this proton-conducting hybrid glass as an electrolyte has high volumetric stability and excellent moisture retention characteristics in high and intermediate temperature ranges.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a schematic view showing the process of manufacturing proton-conducting hybrid glass according to Example 1;

FIG. 2 is a schematic view showing proton pathways through the CsPWA surface;

FIG. 3 is a graph showing the result obtained by measuring ion conductivity when the proton-conducting hybrid glass manufactured in Example 1 is used as an electrolyte for a fuel cell;

FIG. 4A and FIG. 4B are Field Emission Scanning Electron Microscopy (FE-SEM) pictures of the surface and the inside of the proton-conducting hybrid glass manufactured in Example 1;

FIG. 5A and FIG. 5B are FE-SEM pictures of the surface and the inside of the hybrid glass of Example 1 before being impregnated in a Cs carbonate solution;

FIG. 6 is a graph showing the result of an X-Ray Diffraction (XRD) measurement test, which is performed in (1) of Experimental Example 3; and

FIG. 7A and FIG. 7B are graphs showing the result of a Fourier Transform Infrared (FT-IR) measurement test, which is performed in (2) of Experimental Example 3, in which FIG. 7A is the result of an FT-IR measurement test of CsPWA, and FIG. 7B is the result of an FT-IR measurement test of O—H.

### DETAILED DESCRIPTION OF THE INVENTION

Borosilicate glass is a type of glass that is advantageous in that the size, distribution, and microstructure of pores can be adjusted without compromising mechanical, chemical, or thermal stability.

The present invention provides hybrid glass having proton-conducting characteristics, in which cesium (Cs) salt-substituted Phosphor Tungstic Acid (PWA) is created inside pores of porous borosilicate glass.

The composition of the proton-conducting hybrid glass can be expressed by formula 1 below:

CsₓH₃₋ₓPW₁₂O₄₀ Formula 1,

where x is a real number that indicates the amount of cesium that is substituted. x satisfies the relationship: 0.5≦X<3.0, and more preferably, the relationship: 2.5≦X<3.0.

PWA is substituted with a metal salt, Cs₂CO₃, such that Cesium salt of phosphotungstic acid (CsPWA) is created inside the pores of the borosilicate glass.

PWA is a solid inorganic material that belongs to a heteropolyacid group, and is a type of solid acid that is not sensitive to water, rapidly reacts, is easily separated from a product after a reaction, and is reproducible. PWA has a Keggin structure, that is, a primary structure. It is known that a PW₁₂O₄₀ molecule is configured such that octahedral W₁₂^{O}₃₆, which contains coordinate atoms, surrounds tetrahedron POn-, which contains a center atom P, while sharing oxygen atoms with tetrahedron POn-. The ratio of the central atom to the coordinate atoms is 1:12. In addition, several structures, such as the Dawson structure (2:18) and the Anderson structure (1:6), are classified according to the ratio of the number of the central atoms to the number of the coordinate atoms. The Keggin structure is most frequently used due to the ease of manufacture and stability. pm CsPWA is a compound that is produced through the substitution of Cs⁺ in Cs₂CO₃. CsPWA has a great surface area and is not easily dissolved in water, since the solvation energy of cations is low.

In Formula 1 above, the value of x can be set to be 0.5 or more by adjusting concentration. If x is 3, no H group exists in H₃P₁₂O₄₀. This may cause a problem in that an ion conduction path, i.e. an ion conduction pathway that is formed by the CsPWA created inside glass no longer exists. If x is 2.5 or more, the pore size of CsPWA is 8.5 Å or more, both mesopores and micropores exist, a porous space is maintained, and the surface area is increased. It is most preferable that x fall within the range 2.5≦x<3. In a specific example, the particle size of Cs_{2.5}H_{0.5}PW₁₂O₄₀ ranges from 8 nm to 10 nm, and the surface area is about 130 m²/g.

The proton conductivity of heteropolyacid compounds is in the range from 0.06×10⁻⁵S/cm to 2×10⁻⁵S/cm. PWA also has high proton conductivity as a heteropolyacid compound, and thus can be bonded with Cs⁺, a metal salt, thereby creating CsPWA, which has high thermal stability and water resistance. Accordingly, proton-conducting hybrid glass can be produced using CsPWA.

Chemical fragility can be overcome using the dispersed borosilicate porous glass. By gradually creating solid heteropolyacid, which has strong elution tendency and proton conductivity, from the inside of the pores of glass, proton-conducting hybrid glass similar to conventional glass, which contains molecular water, can be produced.

In addition, the proton-conducting hybrid glass is successfully manufactured in the present invention.

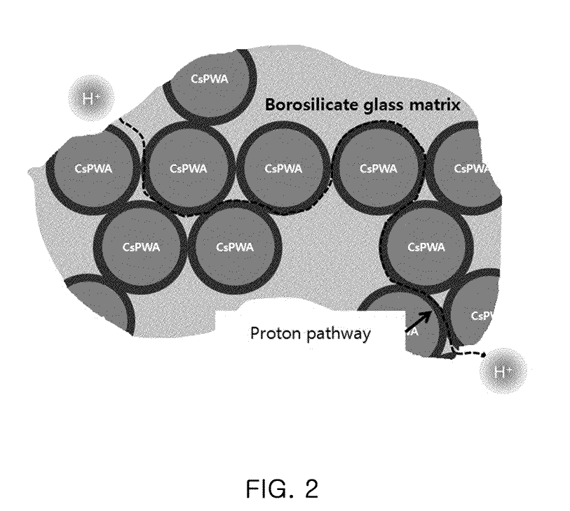

CsPWA is created inside the pores of the porous borosilicate glass through impregnation in a Cs carbonate solution and a PWA solution. The dispersed porous borosilicate glass, which has mechanical, chemical, and thermal stability, is used. The porous borosilicate glass is imparted with proton conductivity by creating Cs⁺-substituted PWA, i.e. CsPWA, inside the pores of the glass matrix. The concept of this mechanism is shown in FIG. 2.

In order to manufacture proton-conducting hybrid glass of the present invention, a method for manufacturing a proton-conducting hybrid glass has a cycle that includes the step of impregnating porous borosilicate glass, which contains pores therein, in a Cs carbonate solution, and the step of re-impregnating the porous borosilicate glass, which is impregnated in the Cs carbonate solution, in a PWA solution, thereby creating CsPWA inside the pores of the borosilicate glass.

In addition, the method may also include the step of wiping the surface of the borosilicate glass, with the CsPWA created inside the pores thereof.

It is preferred that the porous borosilicate glass be impregnated in a Cs carbonate solution that has a molecular concentration from 0.1M to 0.5M for 20 to 40 minutes. In the re-impregnating step, the porous borosilicate glass, which has passed through the impregnation in the Cs carbonate solution, is preferably impregnated again in a PWA solution that has a molecular concentration from 0.01M to 0.3M for 20 to 40 minutes. If the concentration of the Cs carbonate or the concentration of the PWA is beyond the above-defined range, or the impregnation time is beyond the above-defined range, Formula 1 above may not be satisfied. It is preferred that the Cs carbonate solution and the PWA solution, which satisfy the above-defined concentration range, be used.

In the process of inducing a reaction inside the pores of the glass by repeatedly impregnating a sample using the Cs carbonate (Cs₂CO₃) solution and the PWA solution, milky precipitates may be created on the surface of the sample. The precipitates may prevent the solution from infiltrating into the pores of the glass, thereby obstructing the process of creating CsPWA particles. Therefore, in order to prevent or remove the phenomenon in which the precipitates covers the surface due to the reaction rate of CsPWA, the process of wiping the surface of the porous borosilicate glass with CsPWA created inside the pores thereof can be carried out when respective cycles are finished.

It is preferred that this manufacturing method further include the step of, after the cycle is repeated 15 to 25 times, removing the unreacted group by drying the resultant product at a temperature ranging from 60° C. to 80° C. for 18 to 30 hours and wiping the resultant product. If the cycle is less than 15 times, there is a problem in that the open poles of the pores of the porous glass cannot be sufficiently closed. In addition, the CsPWA created on the surface of the glass has weak mechanical strength and is not perfectly fixed to the surface of the glass. Then, typical ultrasonic wiping cannot be performed. Therefore, it is preferred that the unreacted group be removed by performing the drying process at a temperature ranging from 60° C. to 80° C. for 18 to 30 hours and then the wiping process.

In addition, the present invention provides a fuel cell that employs a proton-conducting hybrid glass as an electrolyte.

The use of the proton-conducting hybrid glass as an electrolyte can simplify processing and reduce cost. In particular, when the glass is used as an electrolyte, a low temperature melting process, in which an electrolyte film is formed by spraying aerosol or using slurry, can be advantageously employed.

The present invention will be described more fully hereinafter in conjunction with exemplary embodiments so that a person having ordinary skill in the art will be ready to make and use the invention. It is to be understood, however, that the present description is not intended to limit the invention to those exemplary embodiments, but the present invention can be embodied in various forms.

### EXAMPLE

### Manufacture of Proton-Conducting Hybrid Glass (Electrolyte)

A Cs carbonate (Cs₂CO₃) solution, which was produced by dissolving Cs carbonate into 10 ml water, was infiltrated for 30 minutes into porous borosilicate glass (Duran® glass filter disc) for 30 minutes.

Afterwards, a 0.12M PWA solution, which was produced by dissolving PWA into 10 ml water, was infiltrated for 30 minutes into the porous borosilicate glass, which was impregnated in the Cs carbonate solution.

Subsequently, CsPWA precipitates created on the surface of the sample were wiped.

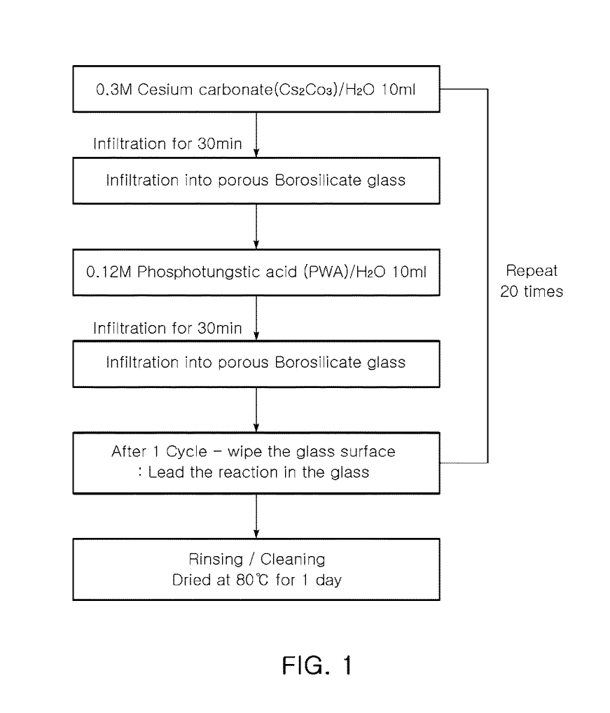

After these processes were repeated 20 times, the unreacted group was removed through complete drying at 80° C. for 24 hours and then wiping. Finally, proton-conducting hybrid glass with CsPWA created in the pores thereof was manufactured. The schematic process of the manufacturing method of the present invention is shown in FIG. 1.

### Experimental Example 1

### Ion Conductivity Measurement

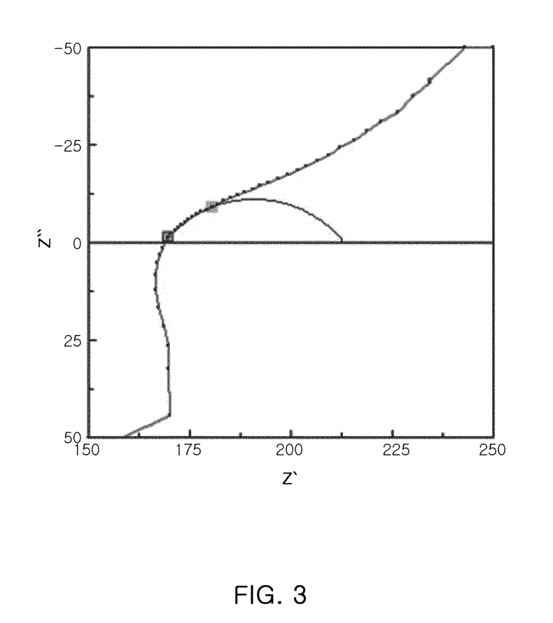

In order to determine whether or not the proton-conducting hybrid glass is suitable to be used as an electrolyte of a fuel cell, the ion conductivity was measured. The results are presented in FIG. 3.

The ion conductivity measurement test was performed by fixing both sides of the proton-conducting hybrid glass with Au electrodes using an AC impedance analyzer (Solatron, SI 1287, SI 1260, available from ULVAC KIKO Inc.). Resistance in the thickness direction of the glass was measured using Nyquist plots, and then conductivity was obtained according to Equation 1 below. The resistance was calculated to be about 40Ω. When the cross-sectional area and thickness were applied to the resistance the ion conductivity was found 10⁻²S/cm, which is within the range available for the electrolyte for a fuel cell.

σ=1/(R×A) Equation 1

In Equation 1 above, σ is the ion conductivity (S/cm), R is the resistance (Ω), and A is the area of the glass.

### Experimental Example 2

### FE-SEM Measurement

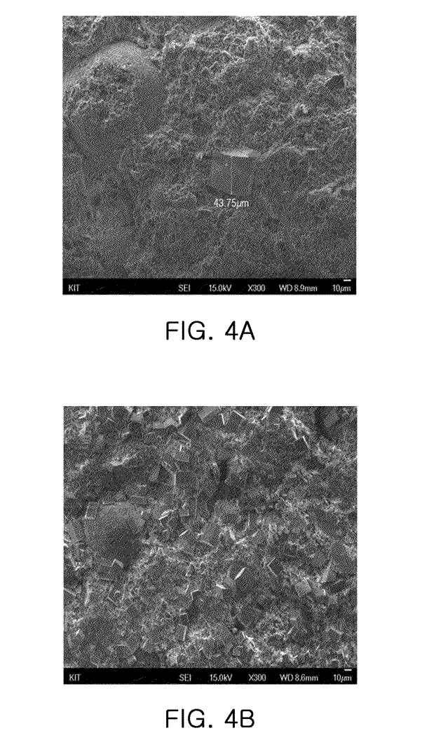

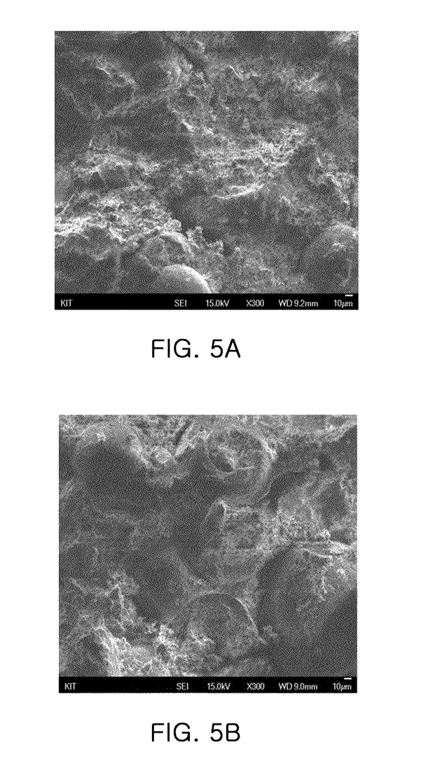

The microscopic structure of the CsPWA infiltrated into the proton-conducting hybrid glass, which was manufactured in Example 1, using a Field Emission Scanning Electron Microscope (FE-SEM). The results are presented in FIG. 4A and 4B. FIG. 5A and FIG. 5B are FE-SEM pictures of the surface and the inside of the hybrid glass (Duran® glass filter disc) of Example 1 before being impregnated in the Cs carbonate solution.

Comparing FIG. 4A and FIG. 4B to FIG. 5A and FIG. 5B, it can be found that the CsPWA was created on the surface and inside the pores of the proton-conducting hybrid glass.

### Experimental Example 3

### CsPWA Crystal Structure Measurement

In order to determine the crystal structure of the CsPWA created on and inside the proton-conducting hybrid glass, which was manufactured in Example 1, X-Ray Diffraction (XRD) measurement and Fourier Transform Infrared Spectroscopy (FT-IR) measurement were performed as follows.

### (1) XRD Measurement

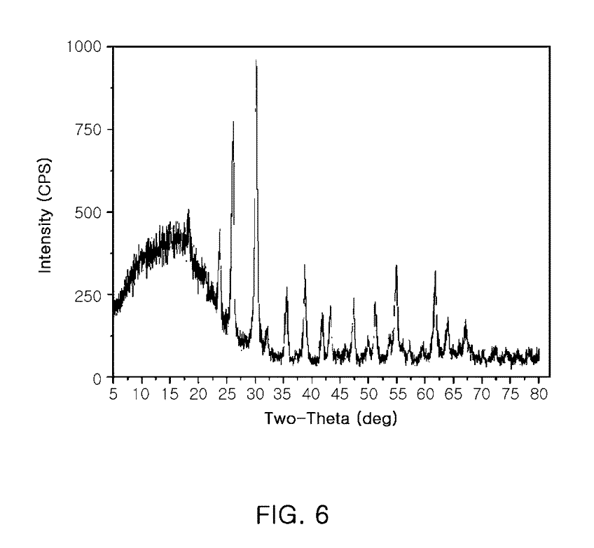

The XRD measurement was performed at a rate of 1°/min in the range of 20 from 5° to 80° using CuKα (40 kV-100 mA). The results are presented in FIG. 6. Referring to FIG. 6, peaks that represent Keggin structures can be found at 26°, 30°, and 38°.

### (2) FT-IR Measurement

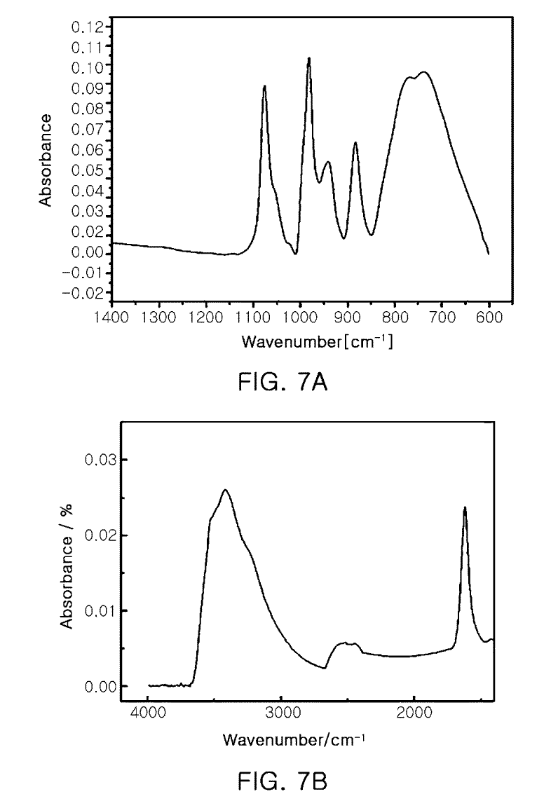

As an infrared spectroscope, VERTEX-70 (Hyperion 2000, available from Bruker Optic) was used. The results are presented in FIG. 7A and FIG. 7B. Referring to FIG. 7A, the Keggin structure of the CsPWA created in the inside pores of the proton-conducting hybrid glass can be appreciated from the bonding of coordinate atoms around the oxygen atom (1077 cm⁻¹: P—O, 884 cm⁻¹: W—O_{c}—W, 769-739 cm⁻¹: W—Oₑ—W). Here, W═O is observed in the range from 941 cm⁻¹ to 983 cm⁻¹. It was reported that 941 cm⁻¹ indicates H⁺(H₂O)ₙ, and that 983 cm⁻¹ is Cs⁺ that has an effect on W═O. Referring to FIG. 7B, the O—H group can be found at 3400 cm⁻¹.

These XRD and FT-IR measurement tests reveal that the CsPWA created inside the pores and on the surface of the proton-conducting hybrid glass of the present invention has the Keggin structure. Through this, it can be understood that the glass has high thermal and chemical stability.

Through Experimental Example, it can be understood that the proton-conducting hybrid glass of the invention has high thermal and chemical stability as well as high ion conductivity, since the CsPWA created inside the pores has the Keggin structure. Accordingly, the proton-conducting hybrid glass of the invention is very suitable for an electrolyte of a fuel cell.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A proton-conducting hybrid glass comprising cesium salt of phosphotungstic acid created inside pores of borosilicate glass.

2. The proton-conducting hybrid glass of claim 1, comprising a composition satisfying the following formula:
CsₓH₃₋ₓPW₁₂O₄₀,
where x is a real number that indicates an amount of cesium that is substituted, and satisfies the relationship 0.5≦X<3.0.

3. A method for manufacturing a proton-conducting hybrid glass, the method comprising a cycle that comprises:
impregnating porous borosilicate glass, which contains pores therein, in a cesium carbonate solution; and
re-impregnating the porous borosilicate glass, which is impregnated in the cesium carbonate solution, in a phosphotungstic acid solution, thereby creating cesium salt of phosphotungstic acid inside the pores of the borosilicate glass.

4. The method of claim 3, the cycle further comprises wiping a surface of the borosilicate glass, with the cesium salt of phosphotungstic acid created inside the pores thereof.

5. The method of claim 3, further comprising, after the cycle is repeated 15 to 25 times, removing an unreacted group by drying a resultant product at a temperature ranging from 60° C. to 80° C. for 18 to 30 hours and wiping the resultant product.

6. The method of claim 3, wherein the cesium carbonate solution has a molar concentration ranging from 0.1M to 0.5M.

7. The method of claim 3, wherein the phosphotungstic acid solution has a molar concentration ranging from 0.01M to 0.3M.

8. A fuel cell comprising an electrolyte made of proton-conducting hybrid glass, which has cesium salt of phosphotungstic acid created inside pores of porous glass.
